(19) United States
(12) Patent Application Publication
(10) Pub. No.: US 2025/0032945 A1
(43) Pub. Date: Jan. 30, 2025

(54) Large Language Model-Based AI-Powered Interactive Doll

(71) Applicant: Scott Mechlowicz, Los Angeles, CA (US)

(72) Inventor: Scott Mechlowicz, Los Angeles, CA (US)

(21) Appl. No.: 18/787,968

(22) Filed: Jul. 29, 2024

Related U.S. Application Data
(60) Provisional application No. 63/529,722, filed on Jul. 29, 2023.

(51) Int. Cl. A63H 3/28; A63H 3/00; A63H 3/48; G06F 3/041; G10L 15/22

(52) U.S. Cl. CPC A63H 3/28; A63H 3/001; A63H 3/48; G06F 3/0412; G10L 15/22

(57) ABSTRACT

The present invention is a Large Language Model-Based AI-powered interactive doll that provides personalized content, education, companionship, entertainment and emotional support to children. The doll connects to a large language model (LLM) and uses a microphone, video camera, touch screen and speaker to interact with the child. The integrated LLM provides real-time video analysis capabilities. The accompanying app provides a full suite of customization options for parents to tailor the doll's interactions to their child's needs and preferences. The doll provides a wide range of content, including educational content, homework assistance, entertainment, AI art, video and music generation, companionship and emotional support, and can suggest activities, tell personalized interactive stories, assisting with language learning, play games, and interact with the child in various other ways. The doll can also be used as a monitor, allowing parents to listen in on the child's interactions, and in another embodiment, to livestream video via an internal camera.

### BACKGROUND OF THE INVENTION

### Field of the Invention

The present invention relates to interactive toys, and more particularly to a Large Language Model-Based AI-powered interactive doll that provides real time personalized content, education, companionship, entertainment, and emotional support to children.

Traditional dolls and toys provide limited interaction and engagement. They cannot respond to a child's speech, perform LLM integrated real time video analysis allowing it to perform dynamic scene understanding and action anticipation, facial recognition, and emotion analysis or provide personalized, nuanced and completely unique conversational content in real-time based on the highly specific interactions between the child and the doll. They also lack the ability to navigate a conversation organically in real-time. There is a need for a more interactive and engaging toy that can provide personalized content, education, companionship, entertainment, and emotional support to children in real-time fully utilizing a near flawless human-like response that is hyper-specific and reactive to each moment of interaction with the child.

### SUMMARY OF THE INVENTION

The present invention is a Large Language Model-Based AI-powered interactive doll that surpasses the limitations of traditional AI toys by utilizing a Large Language Model (LLM) such as, but not limited to, ChatGPT, Gemini Formerly known as BARD, Claude, Llama, xAI, Grok, etc., which enables significantly advanced conversational capabilities and personalization. The integration of a large language model in a toy or doll is a significant development, as it allows much more nuanced, and contextually aware interactions. Each interaction with the doll is unique and tailored to the specific moment and context of the conversation and action, ensuring a dynamic and personalized experience. An integral feature of this doll is its LLM integrated real-time video analysis capabilities, allowing it to perform object detection and tracking, dynamic scene understanding and action anticipation, facial recognition, and emotion analysis. This enhances interaction by providing context-aware responses and activities, making the experience more immersive and interactive.

The doll can communicate with children and provide highly unique, personalized content, education, companionship, entertainment, and emotional support. Unlike conventional AI-powered toys, the doll's responses do not provide pre-scripted or limited responses, lack the ability to detect and respond appropriately to emotional cues, and are not limited in their ability to think creatively or offer spontaneous, imaginative interactions. but are generated in real-time by the large language model, taking into account the immediate context of the conversation, including verbal, visual and touch, the child's previous interactions, and the specific preferences set by the parents in the app.

Children may engage with interactive lessons where the real-time video analysis system can recognize and respond to objects shown by the child. Children may draw or paint in real-time while the real-time video analysis system provides suggestions, enhancements, or even interactive storytelling based on their artwork.

The system is able to create interactive stories where children become part of the narrative. It recognizes their actions and decisions, adapting the story dynamically and making them the heroes of their own adventures.

Children are able to read books aloud while the real-time video analysis system follows along, providing pronunciations, definitions, and context for difficult words. The real-time video analysis system may also assist with learning new languages by recognizing objects and providing translations and pronunciations

Children may show their homework to the system, which can provide step-by-step guidance and explanations for math problems, science questions, and more, helping them understand and learn effectively. The real-time video analysis system may help with personal safety by recognizing potential hazards around the home and advising children on safe practices.

Children may follow along with exercise routines tailored to their age and fitness level. The real-time video analysis system can provide real-time feedback on their form and encourage them to stay active.

This use of an LLM ensures that each conversation with the doll is distinctive, fluid, and tailored to the individual's needs. It also enables the doll to remember past interactions and adapt its responses accordingly, which adds a new dimension to the interaction.

The LLM's ability to generate original content, like interactive stories or educational material, further enriches the interaction, providing a highly engaging and personalized experience for the child.

The doll is designed to be portable, mirroring the convenience of a standard child's doll, and is not intended to be a stationary play toy. It connects to a large language model (LLM) such as ChatGPT, Gemini formerly known as BARD, Claude, Llama, xAI, Grok, etc., via Wifi, Bluetooth, or other means of connection, and uses a microphone and speaker to interact with the child. The doll can be embodied as any character, including but not limited to a traditional doll, plush, a dinosaur, teddy bear, licensed characters, or any other form that can house the internal computational device and associated components. The doll can also connect to a parent's phone via Bluetooth and utilize their WiFi and cellular data.

The doll can also be equipped with an optional integrated screen or tablet accessory, which allows the doll to generate AI pictures by accessing AI art generating platforms such as ChatGpt, DALLE, show pictures, show videos, and perform other interactive tasks via the Large Language Model connection related to the conversation in real time. The doll can also access generative music AI platforms such as Suno and generate music together with the child based on the child's input, and can access music from the web. In addition, the doll can generate custom AI videos utilizing generative AI platforms such as Sora based on the child's input or the ongoing interaction.

The accompanying app provides a full suite of customization options, allowing parents to tailor the doll's interactions to their child's needs and preferences. This LLM-powered interaction distinguishes this doll from other AI toys, offering an unprecedented level of engagement, education, entertainment, companionship, entertainment, and emotional support.

### BRIEF DESCRIPTION OF THE DRAWINGS

FIG. 1 is a representation of the interactive doll with component parts shown.

FIG. 2 is a representation of the interactive doll with control system and large language model shown.

FIG. 3 is a block diagram of the control system and large language model.

FIGS. 4a and 4b are flow charts of the user activation process using a button.

FIGS. 5a and 5b are flow charts of the user activation process using a wake word.

FIG. 6 is a flow chart of user interaction with the interactive doll.

FIG. 7 is a flow chart of sensor monitoring of the interactive doll.

FIG. 8 is a flow chart of additional sensor monitoring of the interactive doll.

FIG. 9 is a flow chart of the voiceprint authentication process.

FIG. 10 is a flow chart of media recording and playback with the interactive doll.

FIG. 11 is a flow chart of mood analysis and lighting adjustment.

FIG. 12 is a flow chart of the setup of the interactive doll.

FIG. 13 is a representation of an alternative embodiment of the interactive doll using a computing device.

FIG. 134 is a representation of an alternative embodiment of the interactive doll using a mobile device.

### DESCRIPTION OF THE PREFERRED EMBODIMENT

The following detailed description refers to the preferred embodiment of the disclosed invention as shown in the attached figures and in the below description. This detailed description is not meant to limit the scope of the invention in any way but is intended to disclose the preferred embodiment/best mode of the invention at the time of filing this application.

The LLM based AI-powered interactive entity, hereafter referred to as a “doll” for simplicity, comprises an internal computational device that connects to a large language model (LLM) via Wifi, Bluetooth, or other means of connection. The doll is equipped with a microphone to receive the child's speech and a speaker to output the LLM's responses. The doll's responses are not pre-scripted but are generated in real-time by the large language model, taking into account the immediate context of the conversation, ensuring a dynamic and personalized experience, the child's previous interactions, and the specific preferences set by the parents in the app.

The doll can be embodied as any character, including but not limited to a traditional doll, plush, a dinosaur, teddy bear, licensed characters, or any other form that can house the internal computational device and associated components.

The LLM in the doll can differentiate when the child has finished a thought based on interpreting natural language and pause length, and then reply. For instance, if a pause exceeds a pre-set threshold (e.g., 2 seconds) after the child's speech, it can signal the end of a thought, and the doll can formulate its response. Alternatively, after a child says something, they can squeeze the doll's hand, which contains an internal button. This action sends a signal for the LLM to respond.

In another embodiment, the internal computational device can be inserted into any doll or toy to turn it into an LLM based AI-powered smart doll. This standalone device includes all the features and capabilities of the integrated version, including the ability to connect to a large language model, receive speech input, receive video input/content, output responses, and interact with the accompanying app.

The doll's LLM is programmed to understand that it is communicating with a child. The accompanying app allows parents to input the child's age, and the LLM tailors its language and content to that specific age. The LLM can also adapt its responses based on the child's gender and interests, providing a highly personalized interaction experience.

The accompanying app allows parents to select the voice of the doll, providing further personalization.

The doll can provide a wide range of content, including educational content, entertainment, and emotional support. It can suggest activities, tell stories, play games, and interact with the child in various other ways. For instance, the doll can suggest activities such as crafting a paper airplane, tell interactive stories about space exploration, or teach multiplication via interactive games. The doll can be inquisitive, asking non-prompted questions, striking up conversations at random, and even prompting the child to engage in certain activities or discussions. The content provided can be completely unique and different each time, offering a highly personalized and engaging experience. The doll can learn from past interactions and remember the child's likes and dislikes, further enhancing the personalization over time.

The doll is capable of generating novel and unique stories, games, and educational instructions, highly personalized to the child. The child can suggest story ideas, characters, and games, and the LLM can create content based on these suggestions. The doll can answer the child's specific questions in a highly tailored manner, and can follow along with the child's line of questioning, even if it involves imaginative scenarios or theories.

Children may engage with interactive lessons where the real-time video analysis system can recognize and respond to objects shown by the child. For example, the device identifies different types of leaves, animals, or historical artifacts, providing detailed information and fun facts. The system may guide children through safe, at-home science experiments, recognizing materials and ensuring correct procedures are followed, while explaining scientific concepts in real-time.

Children may draw or paint in real-time while the real-time video analysis system provides suggestions, enhancements, or even interactive storytelling based on their artwork. The system identifies elements of their drawings and create animations or stories from them. Using real-time video, children may learn new dance moves or musical instruments. The system provides feedback on their movements or play along with them, creating a fun, interactive musical experience.

The system is able to create interactive stories where children become part of the narrative. It recognizes their actions and decisions, adapting the story dynamically and making them the heroes of their own adventures.

Children are able to read books aloud while the real-time video analysis system follows along, providing pronunciations, definitions, and context for difficult words. The system also asks questions to ensure comprehension and make reading more engaging. The real-time video analysis system may also assist with learning new languages by recognizing objects and providing translations and pronunciations. It engages in conversational practice, helping children improve their speaking skills.

Children may show their homework to the system, which can provide step-by-step guidance and explanations for math problems, science questions, and more, helping them understand and learn effectively. The real-time video analysis system may help with personal safety by recognizing potential hazards around the home and advising children on safe practices. For example, the system alerts them to avoid touching hot surfaces or remind them to wash their hands.

Children may follow along with exercise routines tailored to their age and fitness level. The real-time video analysis system can provide real-time feedback on their form and encourage them to stay active. For young athletes, the system offers tips and techniques for improving their skills in various sports, analyzing their movements and providing personalized coaching.

The real-time video analysis system identifies and tracks objects in real-time as they move within the video. This includes detecting multiple objects simultaneously and tracking their movements accurately. The system understands and interprets the overall scene, recognizing various elements and their interactions within the environment.

The system is capable of comprehending the context of the scene, recognizing activities and predicting subsequent actions. For instance, it is able to identify a person walking and anticipate their path or actions. The system maintains consistency across frames, ensuring that objects and people are accurately represented throughout the video.

The system is capable of detecting and recognizing faces in real-time, useful for applications like security and personalized user experiences. Additionally, the system analyzes facial expressions to determine the emotional state of individuals, providing insights into group dynamics or user reactions.

Further, the system is able to read and extract text from video frames, such as reading signs, labels, or subtitles within the video. The tool adds text overlays, captions, or annotations in real-time, useful for educational videos.

The system combines video with audio processing to provide a comprehensive interactive experience, allowing users to interact with the system using both video and voice commands. Communication improves over time, learning from interactions to provide more accurate and personalized responses.

The doll is not simply passive, but can proactively and spontaneously suggest things to do with the child. The child can also tailor the genre and theme of stories and games simply by asking the doll.

In another embodiment, the doll can also be equipped with an optional integrated screen or tablet accessory, which allows the doll to generate AI pictures by accessing AI art generating platforms such as ChatGpt, DALLE, show pictures, show videos, and perform other interactive tasks via the Large Language Model connection related to the conversation in real time. The doll can also access generative music AI platforms such as Suno and generate music together with the child based on the child's input, and can access music from the web. In addition, the doll can generate custom AI videos utilizing generative AI platforms such as Sora based on the child's input or the ongoing interaction.

The doll has strict parental guidance settings to ensure the content is always appropriate for the child. Parents can control these settings and other parameters through the accompanying app. The app also allows parents to monitor the child's interactions with the doll and receive updates on the child's progress.

The doll can access any LLM plugins, agents, and Custom GPTs based on the parents' selection to enhance its scope of functionality. Many of which have interaction with allowing for tangible results such as adding the child's favorite foods to the parents' Instacart order or requesting an Uber to pick them up from camp, etc. via Plugins, Custom GPTs and agents built within the LLM.

The doll can also weave educational content into conversations and games organically, making learning fun and engaging. The doll can assess the child's skills in real-time and tailor its educational content accordingly. This allows the doll to provide a personalized learning experience that adapts to the child's progress and needs.

On a social and emotional level, the doll can provide support and guidance to the child. For example, if the child expresses sadness over a lost toy, the doll can offer empathetic responses, or even suggest a fun distraction, based on a psychology data set tailored for children. It can help the child navigate difficult situations and emotions, build confidence, and prepare for new experiences. The LLM is trained on a vast psychology data set, allowing it to provide nuanced and sensitive responses to a wide range of emotional situations. The doll can also provide emotional support, helping the child to express their feelings and navigate their emotions in a healthy way.

Parents can initiate a well-being check via their app, and the doll will organically begin a process of questioning to ensure the child is doing emotionally well, utilizing its psychology data set. This process is done in a non-intrusive and supportive manner, helping to guide the child's emotional well-being while maintaining a positive and engaging interaction. This will trigger an alert to the parents.

If a child is behaving in a way that the parents find undesirable, they can input this information into the app. The AI will then subtly and organically steer the child towards more desirable behavior through their interactions. This is done in a non-intrusive and supportive manner, helping to guide the child's behavior while maintaining a positive and engaging interaction.

The doll is equipped with a rechargeable battery, making it easy to use and environmentally friendly. It can also function as a sleep aid, telling stories to help the child fall asleep, and waking the child up gently at a specified time with talking, singing, or any other method chosen by the parents in the app.

The doll can also be used as a monitor, allowing parents to listen in on the child's interactions. For example, the audio stream can be accessed via the app, allowing for real-time monitoring or playback of recorded interactions. In another embodiment, the doll can also livestream video via an internal camera, allowing parents to watch their child's interactions in real time.

The doll can tell interactive stories. The child can choose the characters, setting, and plot, and the doll can create a story based on these choices. This encourages the child's creativity and imagination.

Health Reminders: The doll can remind the child to perform healthy habits such as washing hands, brushing teeth, exercising daily, and drinking water. These reminders can be scheduled and customized through the parent's app.

Homework Assistance: The doll can assist the child with their homework. For instance, if a child is struggling with a math problem, children can show their homework to the system, which can provide real time step-by-step guidance and explanations for math problems, science questions, and more, helping them understand and learn effectively.

Alternatively, the child can verbalize the problem to the doll, The child can ask the doll questions about their homework, and the doll can provide explanations and guidance. This makes homework less stressful and more enjoyable for the child.

Sleep Monitoring: The doll can monitor the child's sleep patterns. It can track when the child falls asleep and wakes up, how long they sleep, and the quality of their sleep. This data can be sent to the parents' app, allowing them to monitor their child's sleep health.

Language Learning: The doll can also be programmed to teach the child a new language. For example, it can initiate a simulated shopping trip in French, teaching vocabulary for different foods and how to ask for them. It can converse with the child in the chosen language, correct their pronunciation, and teach them new words and phrases. This provides a fun and interactive way for children to learn a new language.

Parental Alerts: The doll can send alerts to the parents' phones if it detects something unusual, like the child being upset for an extended period, not engaging in usual activities, or mentioning something concerning during their conversations. This allows parents to intervene or provide support when necessary.

In another embodiment, the doll can also connect to other smart devices in the home, allowing it to control lights, play music, and perform other tasks as directed by the child or parents. For example, the doll could help a child establish a bedtime routine by dimming the lights and playing lullaby music at a preset time. Safety and Privacy Measures: Given that the invention involves collecting and processing data from children, it is designed to comply with all relevant regulations such as the Children's Online Privacy Protection Act (COPPA) and GDPR (for users in the European Union). The doll employs robust end-to-end encryption mechanisms, ensuring that all data transmitted between the doll, the large language model (LLM), and the associated app is secure and cannot be intercepted or misused.

Parental consent is required for the use of the doll and its accompanying app. The setup process of the doll will include clear information on data handling, intended use, and security measures. Parents will be required to provide consent before the doll starts collecting or processing any data from the child. Parents will also have the ability to manage and review all the data collected by the doll through the accompanying app. They can modify, delete, or restrict the data at any time, providing complete control over their child's data. All data collected by the doll is anonymized and is not used for any purposes other than to improve the interaction between the child and the doll. The data is never shared with third parties or used for advertising purposes.

The AI-Powered Interactive Doll also implements advanced cyber security measures to protect against any potential cyber threats or attacks. It includes features such as automatic security updates, strong authentication mechanisms, and a secure boot process to prevent unauthorized access.

In terms of physical safety, the doll is designed and manufactured following all relevant toy safety standards. This includes using non-toxic materials, minimizing small parts to prevent choking hazards, and securing any electronic components to prevent access by the child.

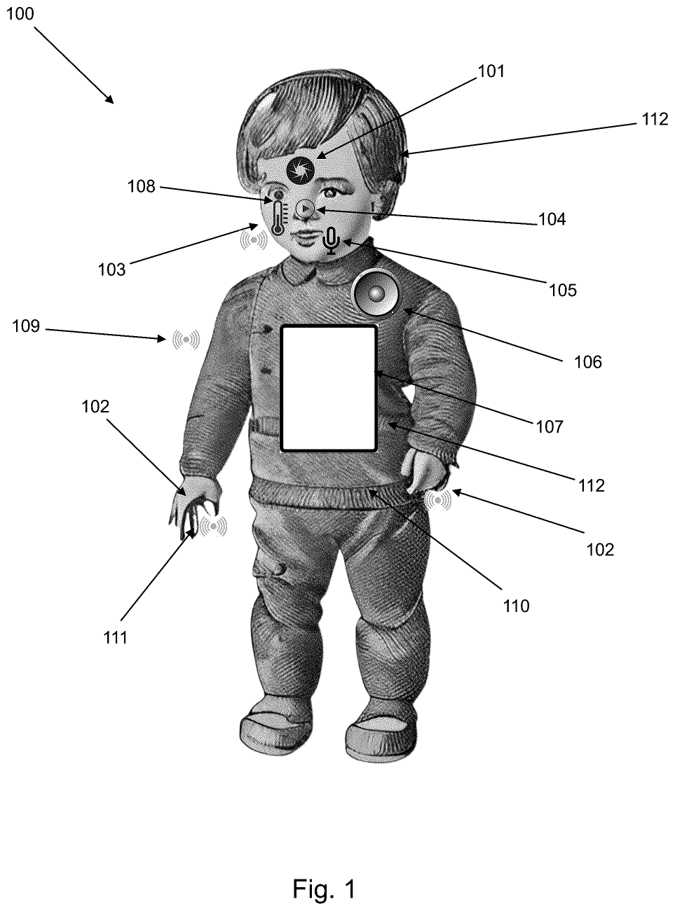

FIG. 1 is a representation of interactive doll 100 showing all of its component parts. Interactive doll 100 may be made in any form, as a doll, plush toy, animal, action figure, or any other figure. Interactive doll 100 may also take the form of an inanimate object. The representation of interactive doll 100 as a doll in this figure should not limit the shape of the device to any particular type, representation, size or material of manufacture. Hand sensors 102 are integrated into the doll's hands to detect holding or squeezing, measuring the pressure applied. Hand sensors 102 may be capacitive, resistive, or piezoelectric sensors well known in the art. Capacitive sensors detect changes in capacitance when pressure applied. Resistive sensors measure changes in resistance under pressure Lastly, piezoelectric Sensors generate an electrical signal when deformed. Hand sensors 102 are described in relation to these types of sensors but any sensor well known in the art may be utilized. Hand sensors 102 are embedded within the soft fabric of the doll's hands, with protective casing to ensure they are not damaged by handling. Hand sensor(s) 102 are connected to the main circuit board (that includes the microprocessor) of interactive doll 100 via flexible printed circuits (FPCs) to ensure durability and flexibility. The signal from the hand sensors 102 is processed by the microprocessor, which digitizes the analog signals for further processing. Each hand 102 sensor is powered by the doll's internal battery, regulated through a voltage regulator to ensure stable operation.

Body sensor 109 detects holding or squeezing of the interactive doll 100 body. These sensors are embedded in the body of the interactive doll 100 in the same manner as the hand sensors 102. Body sensor 109 is selected from the same types of sensors as hand sensor 102 and connected to the main circuit board in a similar manner. The body sensors are powered using the same power source and their output processed by the microprocessor in the same manner as hand sensors 102.

Head sensor(s) 103 detect touching or patting of the interactive doll's 100 head and operates in the same manner has hand sensor 102 and body sensor 109. Head sensor(s) 102 are integrated into the head's surface material, ensuring they are responsive to touch but protected from wear. Connected to the main circuitry through connectors located at the base of the neck, signals from head sensor(s) 103 are processed by the microprocessor and powered by the internal battery.

It is not required that each of hand sensor 102, body sensor 109 and head sensor 103 be the same type of sensor. Further, additional sensors may be utilized on the interactive doll 100 as may be necessary to support additional functions, including on the doll's legs.

Video camera 101 may be located in the head of interactive doll 100 as an optional feature. Video camera 101 is utilized to capture video footage of the user of the interactive doll 100 as described in this description. In addition to video footage, still images may also be captured. In the preferred embodiment, video camera 101 is a high-definition camera with a resolution of 1920 horizontal pixels and 1080 vertical pixels or higher and is connected to the main microprocessor for data processing. Video captured by video camera 101 may be sent to the LLM for real time analysis.

Microphone 105 is located in the doll's head, near the mouth area for optimal audio capture. In the preferred embodiment, microphone 105 is a high-quality MEMS microphone and is connected to the main microprocessor for signal processing. Any microphone well known in the art may also be utilized.

Button 104, in the preferred embodiment, is located on the nose of the interactive doll 100. Button 104 is momentary push-button switch, made of durable plastic with a soft-touch surface for easy pressing in a small, discreet size, approximately 8 mm in diameter, to fit seamlessly in the nose. Further, button 104 Includes a debouncing circuit or software to ensure reliable operation, eliminating false signals from button presses. Button 104 may be used to wake the doll manually or to start recording. Button 104 is connected to the main circuit board via flexible printed circuits, so that signals from it may be processed by the microprocessor.

Temperature sensor 108 is an optional feature of interactive doll 100. Temperature sensor 108 may be utilized to monitor the body temperature of the user or the ambient temperature of the present environment. Temperature sensors 108 are Integrated into the doll's body, particularly in areas where the child is likely to have close skin contact (e.g., chest, back), and in the preferred embodiment are infrared type temperature sensors. Temperature sensors 108 are connected to the main circuit board (and microprocessor) via flexible printed circuits (FPCs) to ensure reliable data transmission and are powered by the internal battery, with appropriate power management to conserve energy.

Touchscreen 107 is an optional feature of interactive doll 100. A user is able to interact with the touchscreen 107 to navigate menus, select media, draw on the screen, select pre-recorded videos, view images, play games and engage with interactive content. Touchscreen 107 may be integrated into the chest or connected externally and is a high-resolution LCD or OLED screen (1080p 1920×1080 resolution) with a capacitive touch sensor layer. In the preferred embodiment, the touchscreen 107 is sized to fit the interactive doll's body size with approximate diagonal measure of 5 to 7 inches. Capacitive sensor layer of touchscreen 107 detects touch input and send signals to the microprocessor. Touchscreen 107 is connected to the main circuit board to communicate with the microprocessor. A dedicated graphics processing unit (GPU) may be included for rendering high-quality images and videos. Touch gestures such as tap, swipe, pinch-to-zoom and multi-touch features may be supported.

Interactive doll 100 may also include other optional sensors including accelerometer 110 that detects movement and changes in orientation, including tilting, shaking, and rotational movements. Accelerometer 110 is mounted on the internal frame of the doll, centrally located in the torso and is 3-axis accelerometer. Data from the accelerometer 110 is continuously monitored and processed by the microprocessor providing real-time feedback on the doll's position and movement.

Another optional sensor that may be included with interactive doll 100 is a heart rate sensor 111. Heart rate sensor 111 is measures the user's pulse/heart rate when they hold or touch the doll's hands or body. Heart rate sensor 111 is formed of photoplethysmography (PPG) sensors embedded within the soft fabric of the doll's hands and body and housed in a protective casing to prevent damage from handling. The PPG sensors are connected to the main microcontroller via insulated, flexible wiring routed through the doll's limbs and torso and powered by the doll's internal battery, with power regulation provided by a dedicated voltage regulator to ensure stable operation. The PPG sensors emit light into the skin and measure the amount of light reflected back, which varies with blood flow, thus performing the heart rate sensor 111 function. Heart rate sensor 111 is connected to the microprocessor which processes the raw signals, filtering out noise and calculating the pulse rate.

Haptic feedback modules 112 are another optional feature that provide gentle vibrations in response to touch or specific interactions. Haptic feedback modules 112 are formed of eccentric rotating mass (ERM) motors provide strong, broad vibrations and linear resonant actuators (LRA) offering precise, localized vibrations.

The modules are distributed across the interactive doll 100 body to enhance tactile experiences. Haptic feedback provided by haptic feedback modules 112 is controlled by the microprocessor.

Lighting 112 is mood lighting involves the use of embedded LEDs that change color based on the child's mood or the doll's activities, providing visual feedback and enhancing the interactive experience. Lighting 112 is comprised of RGB LEDs distributed across the doll's body, with emphasis on visible areas such as the chest, hands, and face. Lighting is connected to the main microprocessor via flexible printed circuits (FPCs).

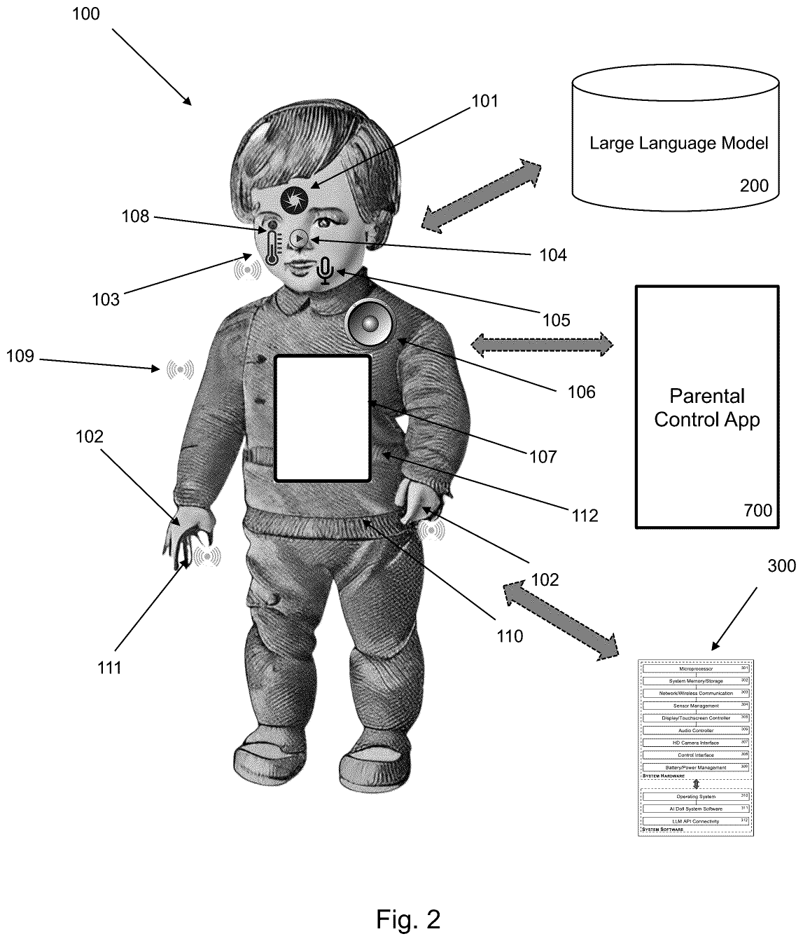

FIG. 2 is a representation of interactive doll with a connection to large language model 200, control system 300 and parental control app 700 shown. The operation of control system 300, large language model 200 and parental control app 700 will be discussed in reference to later figures. Control system 300 forms the hardware and software that controls the features and functions of the interactive doll 100. Large language model (LLM) 200 enables complex and nuanced conversational responses to queries from the user. Parental control app 700 allows the parent to set up and control various features of the interactive doll 100.

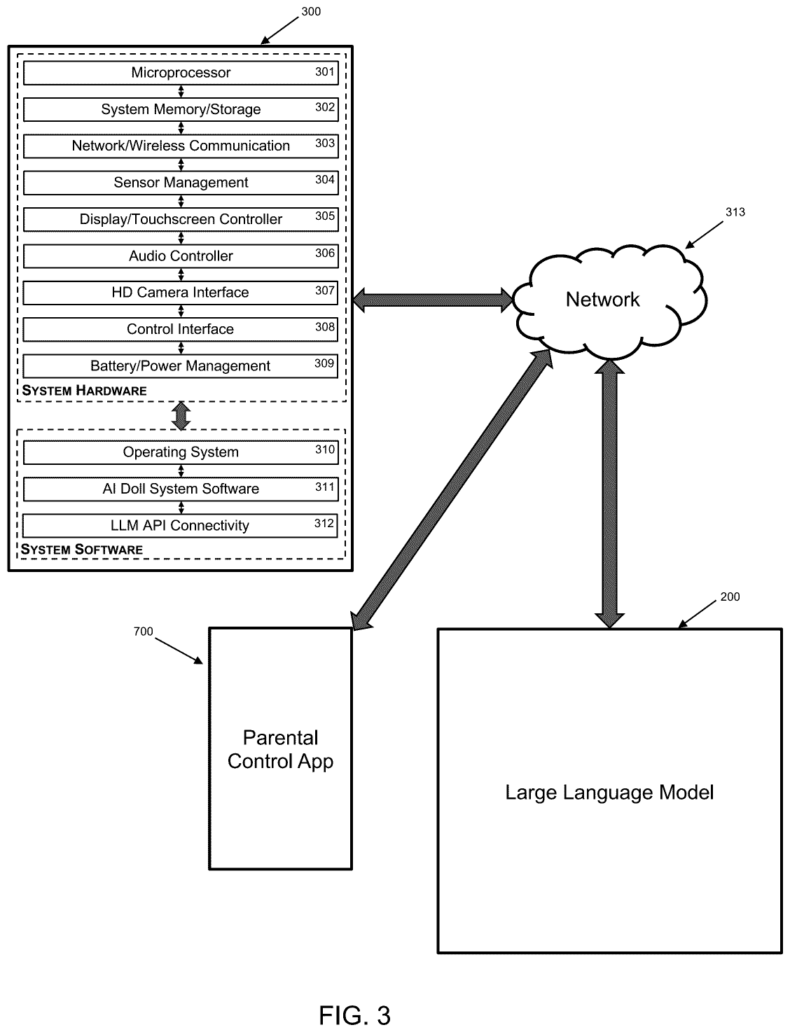

FIG. 3 shows a detailed block diagram of control system 300 as connected to network 313, LLM 200, and parental control app 700. Microprocessor 301 manages real-time data acquisition and response execution. Microprocessor 301 also processes raw sensor data to extract meaningful information. Lastly, microprocessor 301 handles power management and sleep mode activation. In the preferred embodiment, microprocessor 301 is an ARM Cortex-M4 with low-power features, but any microprocessor well known in the art may be utilized.

System memory/storage 302 stores the operating software, input/output, buffer, process audio/visual data, apply parameter updates, and transient operating status for intelligent doll 100. Solid state non-volatile memory such as Flash memory is used in the preferred embodiment. Flash memory stores data even when the power is off. At least 32 GB of flash memory is utilized in the preferred embodiment, but any configuration of memory type and capacity well known in the art may be used.

Network/wireless communication 303 allows the interactive doll 100 to communicate with the network 313 comprising cloud-based services. The preferred embodiment includes WiFi capability to ensure robust and stable network connectivity. WiFi includes dual-band (2.4 GHz and 5 GHZ) support for stable connectivity and WPA2/WPA3 security protocols for secure connections. In an optional configuration, a cellular module provides mobile data connectivity utilizing LTE or 5G cellular connectivity for use in environments without Wi-Fi. In a second optional configuration, a Bluetooth™ module is included for initial setup and local communication.

Sensor management 304 collects inputs from various hand sensors 102, head sensors 103, body sensors 109, temperature sensor 108, accelerometer 110, and heart rate sensor 111. This module collects these inputs from sensors, processes them and sends them to microprocessor 301 for use by the system and large language model 200. Microprocessor 301 converts the analog signals from sensors to digital using built in analog to digital conversion.

Display/touchscreen controller 305 is a graphics processing unit (GPU) that processes data from the system for rendering high quality images and video on the touchscreen. Display/touchscreen controller 305 also processes inputs from the capacitive touchscreen portion of the display. Lighting 112 is also controlled by display/touchscreen controller 305.

Audio controller 306 includes a dedicated Digital Signal Processor (DSP) that processes inputs from microphone 105 and outputs to speaker 106. Inputs from microphone 105 are converted from analog to digital and send to microprocessor 301 and system memory/storage 302 for processing and storage by the system. Once microphone input signals are converted to digital, they can be used to form instructions to the large language model 200 so the interactive doll 100 may perform its intended functions. Audio information collected by the system from the LLM 200 must be converted from digital format to analog that may be utilized by speaker 106.

HD Camera Interface 307 provides connectivity from video camera 101 to the control system of interactive doll 100. HD camera interface 307 processes digital video signals from video camera 101 and transmits them to microprocessor 301 for use in other functions of the doll. Specifically, video input of the user is processed such that it can be transmitted to the LLM 200 for a conversational or content-based response.

Control interface 308 provides connectivity to the various controls of the interactive doll 100 including button 104. Control interface 308 processes inputs from button 104 and any other control interfaces included on doll into a format usable by microprocessor 301 and other control system 300 components. As needed, it may convert analog signals to digital signals for use in the system. For example, button 104 may be used to wake (or trigger sleep mode) the doll. In this case, control interface 308 transmits that wake signal to the battery/power management 309 module and microprocessor 301 to power up those components.

Battery/power management 309 includes connection to the battery power of interactive doll 100. In the preferred embodiment, the doll battery is a rechargeable lithium-ion or lithium-polymer type battery, but any type of battery known in the art may be utilized including other rechargeable types (nickel metal hydride, nickel cadmium) or disposable types such as alkaline. Battery/power management 309 also includes advanced power management features that extend battery life/longevity by managing power distribution, transitions to low-power states, powering down components when not in-use, and powering them only when needed. Specifically, this module includes control circuits for disabling non-essential components like the camera, microphone, and speaker. The module further includes power switches or low-power modes for each peripheral. In the preferred embodiment, Texas Instruments TPS series multi-channel power management integrated circuit (PMIC) may be used but any suitable power management solution well known in the art may also be utilized.

Each of the hardware devices described above (microprocessor 301, system memory/storage 302, network/wireless communication 303, sensor management 304, display/touchscreen controller 305, audio controller 306, HD camera interface 307, control interface 308, battery/power management 309) may be integrated on a single printed main circuit board to enable a compact design and provide maximum durability. Each of the inputs, outputs and sensors described above are connected to the main circuit via flexible printed circuits (FPCs) to ensure durability and flexibility.

Operating system 310 is system software that manages the hardware and software resources of the interactive doll 100. As is well known in the art, operating system 310 provides translation between the machine language of the microprocessor, memory and peripherals and higher level software functions. Existing off the shelf operating systems such as Google's Android™ or Linux may be used, or embedded operating systems such as Embedded Linux, QNX, VxWorks, RIOT and TinyOS may also be suitable. Any suitable operating system well known in the art may be used.

AI Doll System Software 311 is the software that manages the operation of the interactive doll 100. This includes each of the user input types previously discussed (voice, video, sensor, button), the transmission of user input to the LLM, and transmission of communication/content from the LLM back to the user. This software controls the operation of each of the previously described functions, features, peripherals, inputs and outputs. Operation of each of the functions will be described in more detail in relation to flowcharts in later figures.

LLM API Connectivity 312 is software that forms requests and transmits them to and receives them from the API (application programming interface) of the LLM 200. Specifically, this software takes the user inputs as provided by the various input methods described, normalizes them for optimal LLM responses and transmits them to the LLM 200 via the API. The LLM 200 responds with the appropriate communication or content, which is then transmitted back through LLM API connectivity 312 enabling the communication and/or content to be presented via audio/video means to the user,

Network 313 is any suitable network, but in the preferred embodiment, the internet. WebSocket Protocol is used for low-latency, real-time communication. As an alternative, use HTTP/2 for efficient, multiplexed data streams.

### Example WebSocket Implementation

```
Python Example:
Python
import websocket
import json
import pyaudio
def on_message(ws, message):
  # Handle incoming message (response from LLM)
  print(“Received:”, message)
  # Play the audio response through the doll's speaker
  play_audio(message)
def on_error(ws, error):
  print(“Error:”, error)
def on_close(ws):
  print(“Connection closed”)
def on_open(ws):
  # Function to capture audio and send it in real-time
  def capture_audio( ):
    # Configure audio stream
    p = pyaudio.PyAudio( )
    stream = p.open(format=pyaudio.paInt16,
        channels=1,
        rate=16000,
        input=True,
        frames_per_buffer=1024)
    print(“Listening...”)
    while True:
      data = stream.read(1024)
      ws.send(data, opcode=websocket.ABNF.OPCODE_BINARY)
  capture_audio( )
def play_audio(audio_data):
  # Function to play audio data (implementation will depend on
  your hardware)
  pass
websocket.enableTrace(True)
ws =
websocket.WebSocketApp(“wss://api.openai.com/v1/engines/llm/completions”,
          on_message=on_message,
          on_error=on_error,
          on_close=on_close)
ws.on_open = on_open
ws.run_forever( )
```

Large Language Model (LLM) 200 is any of the LLM tools well known in the art, including ChatGPT, Gemini formerly known as BARD, Llama, xAI, Grok and Claude. LLMs provide a significant step forward in communication abilities and are significantly different than previously existing natural language models. While traditional natural language models enable basic conversational abilities in dolls, Large Language Models (LLMs) offer significantly enhanced capabilities due to their advanced architecture and extensive training.

### Key Differences Include

### 1) Scale and Complexity:

Traditional Models are typically trained on smaller datasets with limited vocabulary and contextual understanding. LLMs are trained on massive datasets encompassing diverse topics, languages, and contexts. This extensive training allows LLMs to understand and generate complex and nuanced responses.

### 2) Contextual Understanding:

Traditional models often struggle with maintaining context over longer conversations and may provide generic or off-topic responses. LLMs excel at maintaining context over extended interactions, understanding the flow of conversation, and providing relevant and coherent responses even in complex dialogues.

### 3) Adaptability and Personalization:

Traditional models have limited ability to adapt to individual users and learn from interactions. LLMs are capable of learning from past interactions to personalize responses based on the child's preferences, behaviors, and history, offering a tailored and engaging experience.

### 4) Content Generation:

Traditional models generally provide pre-scripted or limited responses and struggle with generating new content. LLMs can generate novel and unique content such as stories, educational materials, jokes, and songs, creating a dynamic and interactive experience.

### 5) Multimodal Capabilities:

Traditional models are primarily text-based with limited integration of other data types. LLMs process and integrate multiple data types, including text, audio, images, and video, to provide rich and interactive experiences. For example, they can analyze visual data from a video camera to provide context-aware responses.

### 6) Emotional Intelligence and Social Skills:

Traditional models often lack the ability to detect and respond appropriately to emotional cues. LLMs are equipped with advanced capabilities to detect and respond to emotional states, offering empathetic and supportive interactions. They can engage in complex social scenarios, providing guidance and support.

### 7) Flexibility and Creativity:

Traditional models are limited in their ability to think creatively or offer spontaneous, imaginative interactions. LLMs excel in creative thinking, generating imaginative scenarios, and engaging in spontaneous, playful interactions that stimulate the child's creativity and curiosity.

### 8) Continuous Improvement:

Traditional Models are static in nature with limited updates or improvements over time. LLMs are continuously improved and updated with new data, ensuring they stay relevant and up-to-date with the latest knowledge and conversational trends.

By leveraging the advanced capabilities of LLMs, the doll can provide a richer, more engaging, and personalized interaction experience far beyond what traditional natural language models can offer.

### 9) Technical Architecture

LLMs (Large Language Models) are built on advanced neural network architectures, such as transformers, which allow for superior contextual understanding and content generation compared to traditional Recurrent Neural Networks (RNNs) or other simpler architectures used in existing interactive dolls. The transformer architecture enables LLMs to process vast amounts of data in parallel, maintaining contextual coherence over long conversations, which is a significant improvement over traditional models.

10) Integration with Real-Time Data

LLMs integrated into the doll can process real-time data inputs from various sensors (e.g., microphones, cameras) to provide immediate, context-aware responses. This capability allows the doll to understand and respond to the child's current environment and actions, offering a more interactive and engaging experience. Traditional models often lack this real-time processing ability, limiting their responsiveness and adaptability.

### 11) Enhanced Interaction Capabilities

LLMs enable the doll to engage in free-form conversations, generate dynamic and personalized educational content, and integrate with external applications and devices. This provides a comprehensive interactive experience that adapts to the child's evolving interests and needs. Traditional models typically rely on pre-scripted interactions, which do not offer the same level of personalization or adaptability.

### 12) Sophisticated Emotional Intelligence

LLMs incorporate advanced emotional intelligence algorithms that allow the doll to detect and respond to emotional states with nuanced and empathetic interactions. This includes understanding subtle cues from the child's voice and facial expressions, offering support and guidance tailored to the child's emotional needs. Traditional models often provide generic responses, lacking the depth of emotional understanding that LLMs offer.

The interactive doll 100 incorporates LLM 200 utilizing transformer neural network architecture to process and generate natural language responses, providing superior contextual understanding and content generation compared to traditional natural language models. The various sensors integrated into interactive doll 100, including microphones and video camera, with an LLM capable of processing real-time data inputs to deliver context-aware and immediate responses, enhances the interactivity and engagement of the doll.

The real-time video analysis system identifies and tracks objects in real-time as they move within the video. This includes detecting multiple objects simultaneously and tracking their movements accurately. The system understands and interprets the overall scene, recognizing various elements and their interactions within the environment.

The system is capable of comprehending the context of the scene, recognizing activities and predicting subsequent actions. For instance, it is able to identify a person walking and anticipate their path or actions. The system maintains consistency across frames, ensuring that objects and people are accurately represented throughout the video.

The system is capable of detecting and recognizing faces in real-time, useful for applications like security and personalized user experiences. Additionally, the system analyzes facial expressions to determine the emotional state of individuals, providing insights into group dynamics or user reactions.

Further, the system is able to read and extract text from video frames, such as reading signs, labels, or subtitles within the video. The tool adds text overlays, captions, or annotations in real-time, useful for educational videos.

Interactive doll 100 featuring LLM 200 generates dynamic and personalized educational content, interactive stories, and games, adapting to the child's individual preferences and learning progress, significantly surpassing the capabilities of traditional natural language models. Interactive doll 100 with LLM 200 incorporating advanced emotional intelligence algorithms to detect and respond to the child's emotional states, provides empathetic and supportive interactions tailored to the child's emotional needs.

Children may engage with interactive lessons where the real-time video analysis system can recognize and respond to objects shown by the child. For example, the device identifies different types of leaves, animals, or historical artifacts, providing detailed information and fun facts. The system may guide children through safe, at-home science experiments, recognizing materials and ensuring correct procedures are followed, while explaining scientific concepts in real-time.

Children may draw or paint in real-time while the real-time video analysis system provides suggestions, enhancements, or even interactive storytelling based on their artwork. The system identifies elements of their drawings and create animations or stories from them. Using real-time video, children may learn new dance moves or musical instruments. The system provides feedback on their movements or play along with them, creating a fun, interactive musical experience.

The system is able to create interactive stories where children become part of the narrative. It recognizes their actions and decisions, adapting the story dynamically and making them the heroes of their own adventures.

Children are able to read books aloud while the real-time video analysis system follows along, providing pronunciations, definitions, and context for difficult words. The system also asks questions to ensure comprehension and make reading more engaging. The real-time video analysis system may also assist with learning new languages by recognizing objects and providing translations and pronunciations. It engages in conversational practice, helping children improve their speaking skills.

Children may show their homework to the system, which can provide step-by-step guidance and explanations for math problems, science questions, and more, helping them understand and learn effectively. The real-time video analysis system may help with personal safety by recognizing potential hazards around the home and advising children on safe practices. For example, the system alerts them to avoid touching hot surfaces or remind them to wash their hands.

Children may follow along with exercise routines tailored to their age and fitness level. The real-time video analysis system can provide real-time feedback on their form and encourage them to stay active. For young athletes, the system offers tips and techniques for improving their skills in various sports, analyzing their movements and providing personalized coaching.

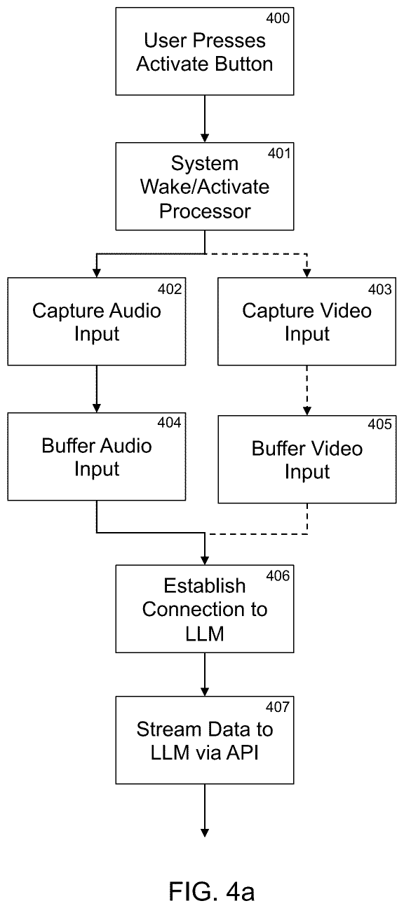

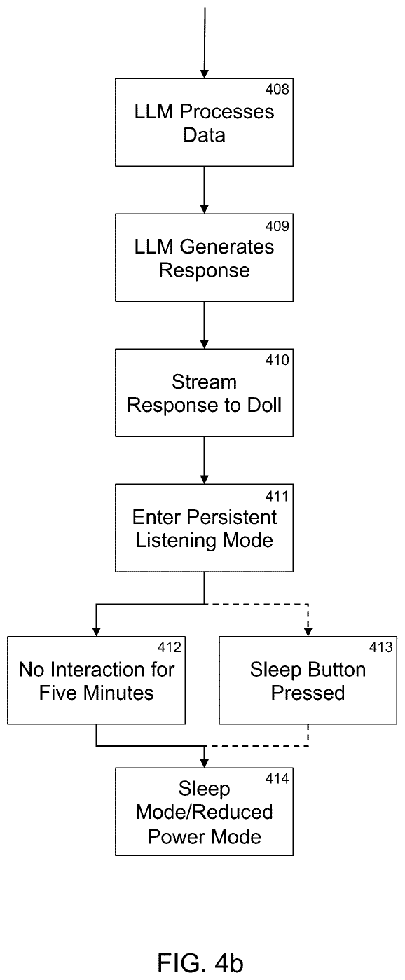

FIGS. 4a and 4b outline the operational flow when a user activates the interactive doll using button 104.

Step 400: User/child presses the Activation Button, embedded in the nose or hand of the interactive doll 101

Step 401: The system wakes and activates the processor.

Step 402: Audio input is captured by the system. Specifically, the user/child says, “Tell me a story.” The microphone captures the child's speech.

Step 403 (Optional): Camera Activation: The high-definition video camera captures the child's facial expressions, gestures, surroundings, visible objects, and any visible activity.

Step 404: The processor buffers the audio input for streaming.

Step 405 (Optional): The processor buffers the video input for streaming and the processor captures visual context from the camera.

Step 406: A connection is established to LLM 200 to transmit the audio and optionally video data collected. The network interface establishes a persistent connection to the LLM 200.

Step 407: Audio and (optionally) video data is streamed to LLM 200 utilizing LLM API connection via WebSocket or HTTP/2 connection for real time processing.

Step 408: LLM 200 processes the streamed audio and visual data. LLM 200 may utilize real-time audio and video processing features to enhance the results provided.

Step 409: LLM 200 generates a response based on the child's input and any visual context provided. LLM 200 may respond with any of the previously outlined educational, creative, gaming, entertainment, language, reading, safety and/or guidance types of content, or any other relevant communication/content generated by the LLM.

Step 410: Response is streamed to doll, audio and optionally video via the established connection. The speaker and touchscreen outputs the verbal response from the LLM.

Step 411: Doll enters persistent listening mode where it waits for audio/video input from the user.

Step 412: If there is no interaction for 5 minutes, the doll automatically enters sleep mode.

Step 413: The user/child may press the button again to manually put the doll to sleep.

Step 414: Sleep mode/low-power state entered. In sleep mode, the doll reduces power consumption by turning off non-essential components and entering a low-power state.

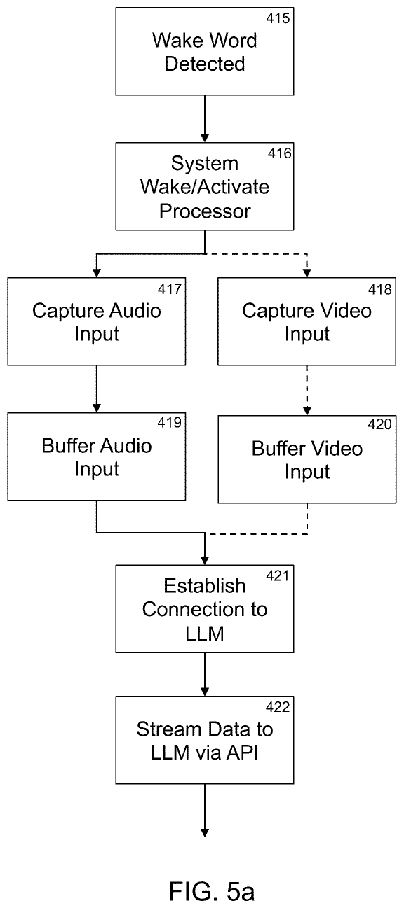

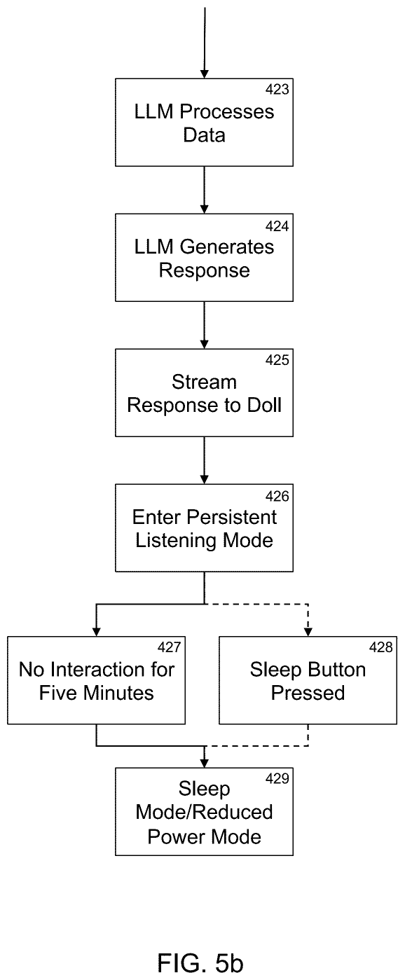

FIGS. 5a and 5b show the operational flow of an optional mode where the interactive doll 100 continuously captures ambient audio waiting to hear a specific wake word. A specialized wake word detection module processes the audio input in real-time to recognize the specific wake word (e.g., “Hey [Doll's Name]”).

Step 415: The wake word detection module uses pre-trained models to recognize the wake word. Upon detecting the wake word, the processor activates fully and begins capturing subsequent audio and visual data.

Step 416: The system wakes and activates the processor.

Step 417: Audio input is captured by the system. Specifically, the user/child says, “Tell me a story.” The microphone captures the child's speech.

Step 418 (Optional): Camera Activation: The high-definition video camera captures the child's facial expressions and gestures.

Step 419: The processor buffers the audio input for streaming.

Step 420 (Optional): The processor buffers the video input for streaming and the processor captures visual context from the camera.

Step 421: A connection is established to LLM 200 to transmit the audio and optionally video data collected. The network interface establishes a persistent connection to the LLM 200.

Step 422: Audio and (optionally) video data is streamed to LLM 200 utilizing LLM API connection via WebSocket or HTTP/2 connection for real time processing.

Step 423: LLM 200 processes the streamed audio and visual data. LLM 200 may utilize real-time audio and video processing features to enhance the results provided.

Step 424: LLM 200 generates a response based on the child's input and any visual context provided. LLM 200 may respond with any of the previously outlined educational, creative, gaming, entertainment, language, reading, safety and/or guidance types of content, or any other relevant communication/content generated by the LLM.

Step 425: Response is streamed to doll, audio and optionally video via the established connection. The speaker, and optionally the touchscreen, outputs the verbal response from the LLM.

Step 426: Doll enters persistent listening mode where it waits for audio/video input from the user.

Step 427: If there is no interaction for 5 minutes, the doll automatically enters sleep mode.

Step 428: The user/child may say a specific phrase like “Goodnight [Doll's Name]” to manually put the doll to sleep.

Step 429: Sleep mode/low-power state entered. In sleep mode, the doll reduces power consumption by turning off non-essential components and entering a low-power state.

By implementing both button activation and wake word detection, the doll can offer flexible and user-friendly interaction methods. The button provides a simple and reliable way to initiate communication, while the wake word detection offers a hands-free, voice-activated option. Both methods ensure real-time communication with LLM 200 providing a seamless and engaging experience for the child. Additionally, incorporating sleep modes ensures efficient power management and prolonged battery life.

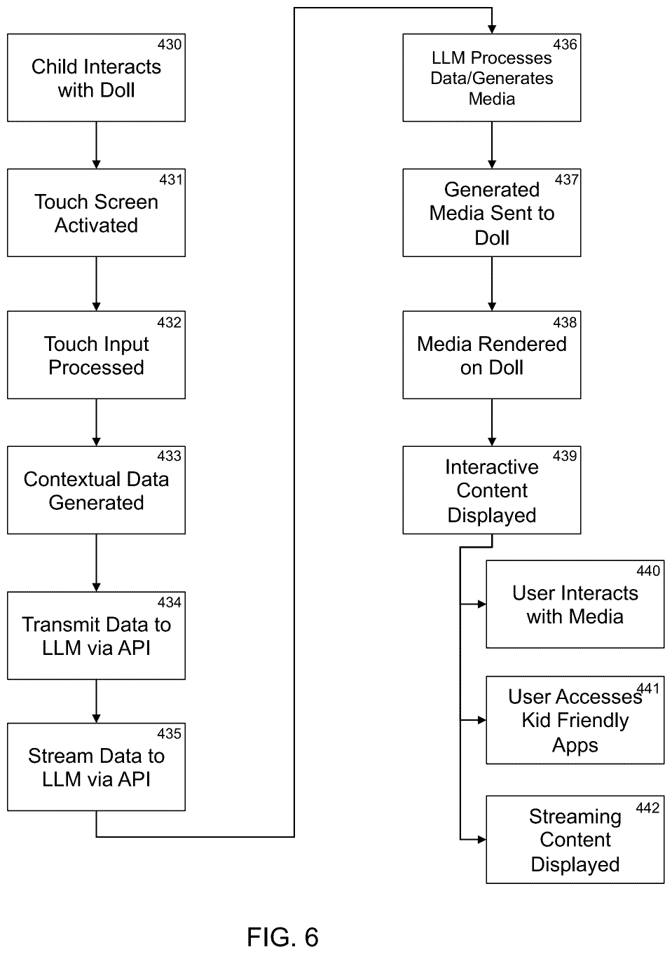

FIG. 6 shows the operational flow of a typical user interaction with interactive doll 100 via touchscreen 107.

Step 430: User/child interacts with doll, by using manually waking the doll with button 104, squeezing the doll's hand, thus activating hand sensor 102, speaking the wake word or touching the touchscreen, depending on the configuration of the doll.

Step 431: The touchscreen is activated and turns on.

Step 432: User inputs request via touchscreen using touch input. The display/touchscreen controller 305 processes the touch input. For example, the user/child interacts with the touch screen or uses a voice command to request content (e.g., “Can you show me a picture of a dinosaur?” or “I want a movie about dinosaurs”).

Step 433: System generates contextual data based on touch input. Contextual data is used to generate a request to be sent to the LLM 200.

Step 434/435: Data is streamed to LLM 200 utilizing LLM API connection via WebSocket or HTTP/2 connection for real time processing. Interactive doll 100 sends a request to the cloud-based AI service, specifying the desired content.

Step 436: LLM 200 processes the request and generates a response based on the child's input and any visual context provided (e.g., a dinosaur image or a dinosaur movie). LLM 200 may utilize real-time audio and video processing features to enhance the results provided. LLM 200 may also respond with any of the previously outlined educational, creative, gaming, entertainment, language, reading, safety and/or guidance types of content, or any other relevant communication/content generated by the LLM.

Step 437: The requested media is sent to the doll for play on the speaker and/or display on the touchscreen.

Step 438: The requested media is rendered on the doll by playing over the speaker and/or displaying on the touchscreen.

Step 439: Interactive content is displayed via one of multiple options for user interaction.

Step 440: The user/child interacts with AI generated media from LLM 200. Cloud-based AI models generate custom videos (e.g., Sora), images (e.g., DALL-E), music (e.g., Suno), and text (e.g., ChatGPT), but not limited to these specific models. Uses advanced models for generating rich media content based on user prompts. Custom AI-generated animations, stories, educational videos, and full-length feature films or TV shows may be generated. Custom drawings, photos, images, illustrations, personalized avatars are also possible to generate. Music such as custom compositions, background music for videos, personalized songs may be generated. User/child may interact with the touch screen to navigate menus, select media, and engage with interactive content. Examples of interactions include drawing on the screen, selecting pre-recorded videos, viewing images, playing games. The display shows AI-generated media, interactive applications, and user interfaces. Dynamic adjustment of brightness and contrast for optimal viewing experience.

Step 441: The user/child may access age-appropriate applications on the touchscreen 107. Access is limited to a curated list of kid-friendly apps such as YouTube Kids, educational games, interactive storybooks. Parents may install additional approved apps through a secure app store. Regular updates ensure apps are up-to-date and secure. Parents may set age-appropriate content restrictions to ensure safe browsing. Filters block inappropriate content and restrict access to certain app features. Parents may also monitor app usage and set time limits. Activity reports provide insights into how the child is interacting with the apps.

Step 442: The user/child may access streaming content via applications such as YouTube Kids, providing access to a wide range of educational and entertaining content. Parents may customize and monitor the content accessible through the app.

By integrating an interactive touch screen, AI-generated media capabilities, and access to kid-friendly apps, the doll provides a rich and immersive experience for children. The detailed technical implementation ensures that the doll may detect and respond to touch inputs, generate custom media content, and display high-quality visuals and audio in real-time. This setup enhances the child's engagement and interaction with the doll, providing endless opportunities for personalized and creative play. Additionally, the inclusion of kid-friendly apps like YouTube Kids allows for streaming online content in a safe and controlled environment.

Features of the LLM may allow it to be continuously aware of what is on the tablet and audio/video content captured by the touchscreen 107, microphone 105 and video camera 101. With this functionality enabled, the interactive doll 100 may comment in real time about the show the child is watching on YouTube and provide the social benefits of watching with a friend. Interactive doll 100 may also use this interaction as a learning cue to discuss about what they learned on the show.

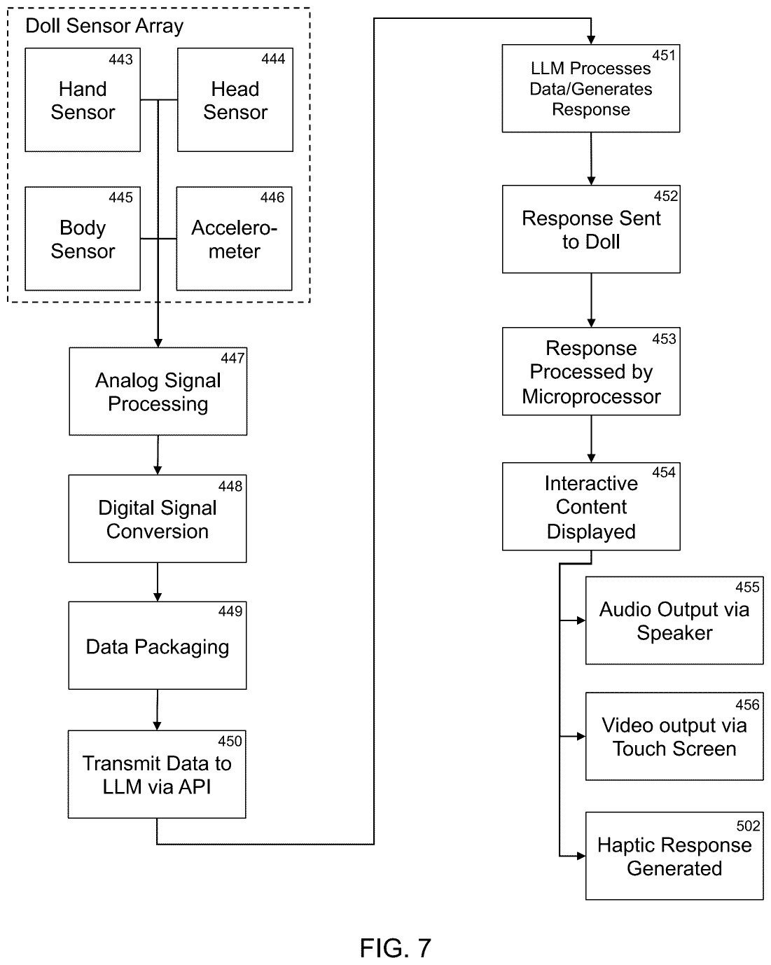

FIG. 7 shows an operating flow for utilization of the various sensors integrated into interactive doll 100 to detect physical interactions such as touch, hugs, and movement. These sensors include hand sensors, a head sensor, body sensors, and an accelerometer. The data from these sensors is processed by the doll's microcontroller and sent to LLM 200 for contextual analysis and response generation.

Steps 443, 444, 445, and 446 each rely on the utilization of the various doll sensors to detect an action taken with the doll by the user.

Step 443: Hand sensor 102 detects pressure that indicates the user/child is interacting with the interactive doll 100, specifically detecting a hug.

Step 444: Head sensor 103 detects pressure that indicates the user/child is interacting with the interactive doll 100, specifically detecting a kiss or pat.

Step 445: Body sensor 109 detects pressure that indicates the user/child is interacting with the interactive doll 100, specifically detecting a hug.

Step 446: Accelerometer 110 Detects movement and changes in orientation, including tilting, shaking, and rotational movements that indicate the user/child is hugging the doll.

Step 447: Analog signal of various sensors converted to a digital signal.

Step 448: Microprocessor 301 processes the sensor data to identify specific interactions, such as a touch, pat, hug, kiss or movement. The processed data includes the type of interaction, its intensity, and its duration. This sensor data is identified as a hug.

Step 449: Contextual data is packaged into a structured format (e.g., JSON) and transmitted to the LLM via a secure API connection, “child is hugging the doll.”

Step 450: Data is sent to LLM 200.

Step 451: The LLM 200 analyzes the incoming sensor data, incorporating it into the context of the ongoing interaction with the child. Based on the analysis, the LLM generates an appropriate response, which could be a verbal acknowledgment, an interactive story, or an educational task. Response “I love your hugs!” with haptic feedback is generated.

Step 452: Response is sent to interactive doll 100.

Step 453: LLM response received by microprocessor. Microprocessor generates an audio, video and haptic response.

Step 454: Interactive content is played by the doll.

Step 455: Audio “I love your hugs” is played through the speaker.

Step 456: Video, if applicable, is displayed on touchscreen.

Step 502: Haptic response played, generating light vibrations in the doll.

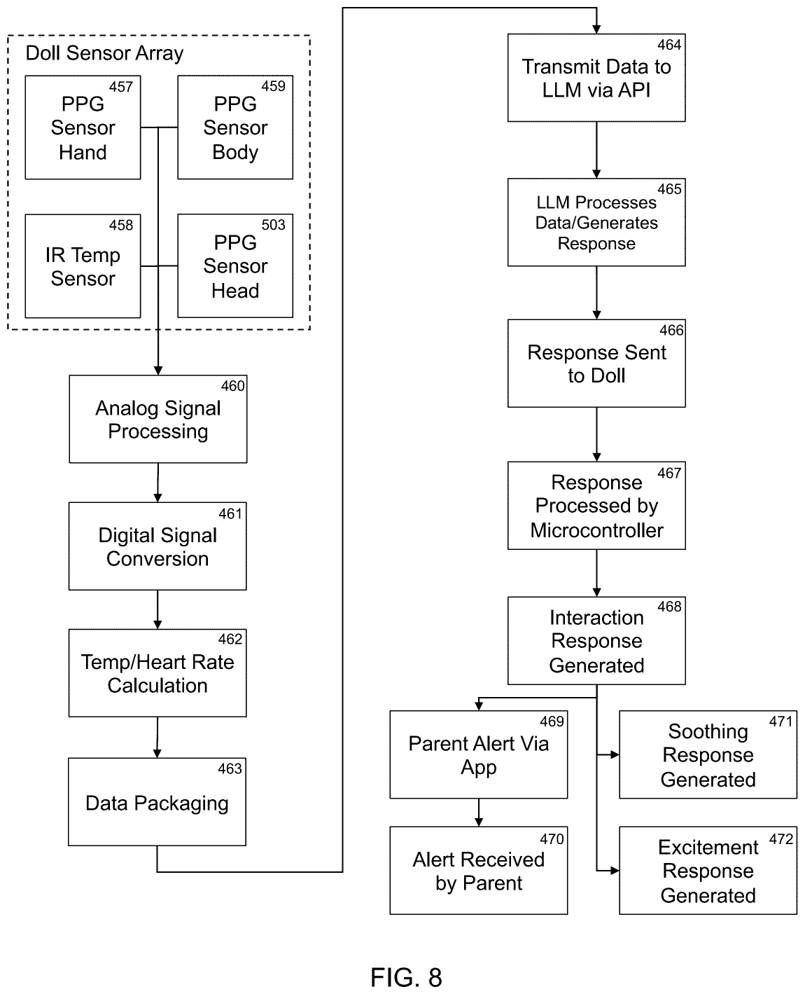

FIG. 8 shows the operational flow of the use of the biometric sensors integrated into interactive doll 100 for monitoring the child's health metrics, such as heart rate and body temperature. These sensors enable the doll to provide real-time feedback, adjust its interaction style based on the child's physiological state, alert parents if significant changes are detected, and enhance the interaction by recognizing and responding to the child's excitement or stress levels. This feature adds a layer of personalization and support, making the doll not only a companion but also a responsive and empathetic entity.

Steps 457, 458, 459, and 503 each rely on the utilization of the various doll sensors to detect an action taken with the doll by the user.

Step 457: PPG hand sensor 111 is a heart rate monitor designed to measure the child's pulse when they hold or touch the doll's hands or body. PPG hand sensor 111 contacts the user/child's body to detect heart rate.

Step 458: IR temperature sensor 108 are embedded in the doll's body, positioned to maximize skin contact for accurate readings. IR temperature sensor 108 detects the user/child's body temperature.

Step 459: PPG body sensor 112 is a heart rate monitor designed to measure the child's pulse when they hold or touch the doll's hands or body. PPG body sensor 112 contacts the user/child's body to detect heart rate.

Step 503: PPG head sensor 112 is a heart rate monitor designed to measure the child's pulse when they hold or touch the doll's hands or body. PPG head sensor 112 contacts the user/child's body to detect heart rate.

Step 460: Analog signal of various sensors converted to a digital signal.

Step 461/462: Microprocessor 301 processes PPG sensor data to calculate the pulse rate, applying algorithms to filter noise and artifacts. The microprocessor 301 processes IR sensor data, applying calibration algorithms to ensure accurate temperature readings.

Step 463: Contextual data is packaged into a structured format (e.g., JSON) and transmitted to the LLM via a secure API connection.

Step 464: Data is sent to LLM 200.

Step 465: The LLM 200 analyzes the incoming sensor data, incorporating it into the context of the ongoing interaction with the child. If the child's heart rate indicates excitement or stress, or if the temperature is outside normal ranges, the LLM adjusts its responses accordingly. For example, it may comment, “You seem excited! Let's do something fun!” or “I see you're a bit warm. How about a cool drink of water?”

Step 466: Response is sent to interactive doll 100.

Step 467: LLM response received my microprocessor. Microprocessor generates an audio, video and haptic response.

Step 468: Interaction response is generated by the interactive doll.

Step 469: Significant changes in biometric data trigger alerts sent to the parents' app. Example Alert:

Json

{“alert”: “High Heart Rate”, “details”: “Your child's heart rate is elevated at 100 bpm.

Step 470: Alert is received by parent on their parent app.

Step 471: Doll generates a soothing response.

Step 472: Doll generates an excitement response.

By integrating these advanced biometric sensors and detailing their technical, electrical, and mechanical aspects, the AI-powered interactive doll can monitor the child's health metrics, provide tailored, real-time responses, and recognize the child's emotional states, ensuring a supportive, safe, and engaging experience.

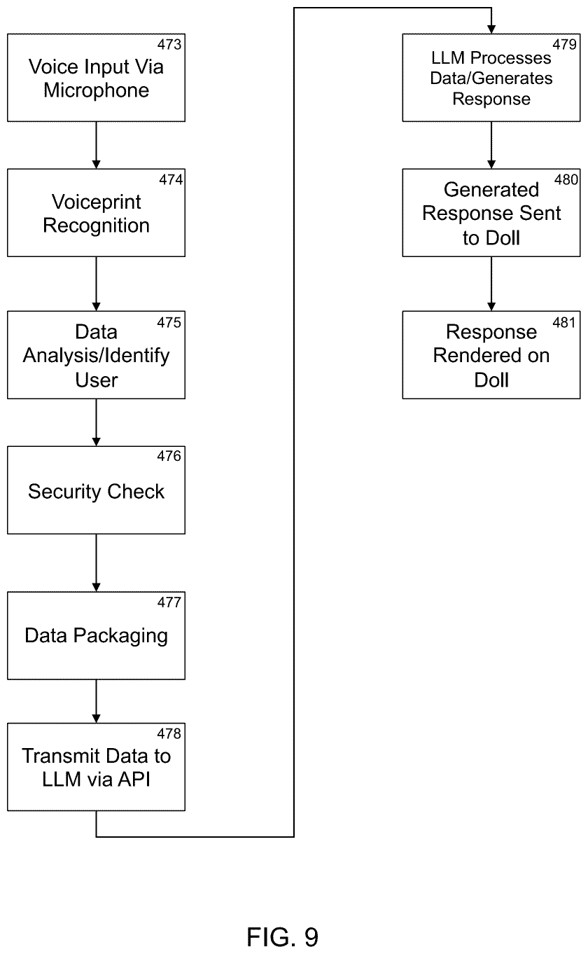

FIG. 9 shows the operational flow of voiceprint recognition enabling the interactive doll 100 to identify individual users based on their unique vocal patterns, allowing for personalized interactions and enhanced security.

Step 473: Microphone 105 captures the child's voice and sends the audio signal to the voiceprint recognition module.

Step 474: Voice is sent to the voiceprint recognition system comprised of a dedicated DSP (Digital Signal Processor) for real-time voiceprint analysis. Pre-trained voiceprint recognition algorithms stored in local memory. The DSP processes the audio signal from the microphone, extracting vocal features and comparing them to stored voiceprints.

Step 475: The DSP processes the audio signal, extracting features such as pitch, tone, and cadence. The extracted features are compared to stored voiceprints to identify the user. Once the user is identified, the doll retrieves their interaction history and preferences from the LLM. The LLM generates a personalized response based on the user's identity and context of the interaction.

Step 476: For sensitive functions, the doll verifies the user's identity before granting access. Unauthorized users are denied access to restricted functions.

Step 478: Data is streamed to LLM 200 utilizing LLM API connection via WebSocket or HTTP/2 connection for real time processing. Interactive doll 100 sends a request to the cloud-based AI service, specifying the desired content.

Step 479: LLM 200 processes the request and generates a response based on the child's input and any visual context provided.

Step 480: The generated response is sent to the doll for play on the speaker and/or display on the touchscreen.

Step 438: The generated response is rendered on the doll by playing over the speaker and/or displaying on the touchscreen.

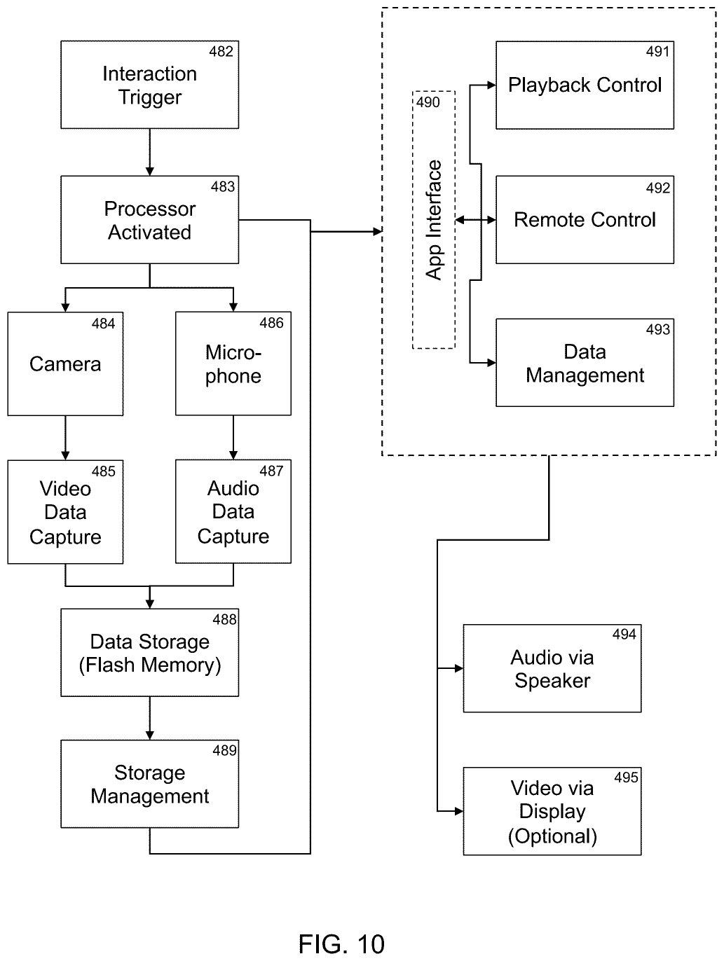

FIG. 10 shows the operational flow of the interactive doll 100 recording video and audio interactions thus enabling playback of special moments, conversations, or activities.

Step 482: Interaction is triggered by pressing button 104 to record video and audio for a predefined duration or until stopped manually. Saves recordings to internal flash memory.

Step 483: The system wakes and activates the processor.

Step 484: The high-definition video camera records video.

Step 485: Video data is captured for storage in local storage.

Step 486: Audio input is captured by the system.

Step 487: Audio data is captured for storage in local storage.

Step 488: Audio and video data are stored in local flash memory.

Step 489: Details of stored audio and video are transmitted to the microprocessor 301 to create a map of items in storage for access at a later date.

Step 490: App interface allows parents to remotely start or stop recordings and access saved files, securely share recordings with family and friends and organize/manage recordings within the app.

Step 491: Recordings may be accessed and played back via the doll's speaker and optional display or through a connected device. Play, pause, rewind, and fast-forward functions are accessible via buttons or voice commands. The doll can comment on or explain parts of the recording during playback.

Step 492: Parents may remotely start or stop recordings and access saved files, securely share recordings with family and friends and organize/manage recordings within the app.

Step 493: Parents may also securely share recordings with family and friends and organize/manage recordings within the app.

Step 494: Selected audio is output via speaker 106.

Step 494: Selected video is output via touchscreen 107.

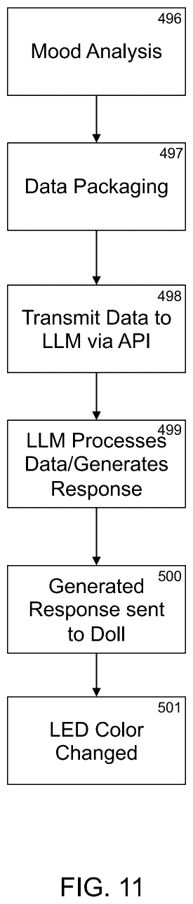

FIG. 11 shows the operational flow of a mode of interactive doll 100 including LED mood lighting. Mood lighting involves the use of embedded LEDs that change color based on the user/child's mood or the doll's activities, providing visual feedback and enhancing the interactive experience.

Step 496: The mood detection software analyzes LLM interaction data, including voice tone and conversation content, to assess the child's mood.

Step 497: Contextual data is packaged into a structured format (e.g., JSON).

Step 498: Mood data is transmitted to the LLM via a secure API connection.

Step 499: LLM generates response based on mood data. Based on the detected mood, the LLM triggers the microcontroller to adjust the color and intensity of the LEDs. Examples include calming blue light for relaxation, bright yellow for excitement, or soothing green for contentment. LEDs may also change color to indicate different activities or states (e.g., green for learning, red for alerts).

Step: 500: Generated response is sent to the interactive doll.

Step 501: LED lighting color changed based on generated response.

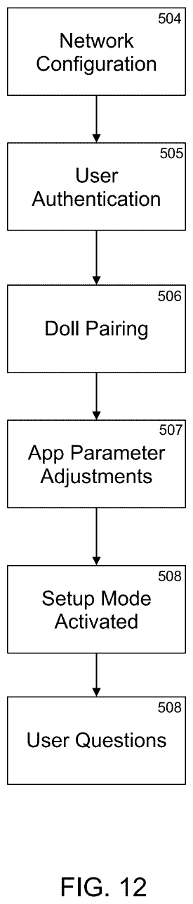

FIG. 12 outlines the operational flow of the initial setup of the interactive doll 100.

Step 504: Setup network configuration. The doll connects to the home Wi-Fi network using an initial setup process (e.g., using a companion setup app or direct connection via Bluetooth). The app connects to the same Wi-Fi network and discovers the doll using mDNS (multicast DNS) or a similar service discovery protocol.

Step 505: User authentication: Parents create an account on the app and log in. The app uses OAuth 2.0 or another secure authentication method to verify user identity.

Step 506: Doll Pairing: The app sends a pairing request to the doll, which is authenticated using a secure token exchange. Once paired, the app and doll establish a secure communication channel.

Step 507: App parameter adjustments: Parents may use a dedicated app to adjust the interaction parameters of the doll to better suit their child's needs. The app allows for broad customization, enabling parents for example to Adjust Focus Areas including 1) Educational Content: Increase or decrease the emphasis on educational conversations, 2) Social Interaction: Adjust the doll's focus on social skills and interactions, 3) Emotional Support: Enhance the doll's ability to provide emotional support and understanding, 4) Entertainment: Modify the balance of playful and entertaining interactions, 5) Set time limits.

Parents may also select specific topics or activities they want the doll to focus on, such as science, math, reading, or social skills. They can also choose to emphasize emotional support, helping the doll provide comfort and understanding during interactions.

The app provides sliders or toggle options to easily adjust the doll's focus areas. Changes are synced with the doll in real-time, ensuring immediate adaptation to new settings, which are then relayed to the LLM for future interactions.

Parents may monitor the interactions and receive feedback on how the doll is engaging with their child. This feedback may be used to further refine and adjust the interaction parameters. Parents access the user interface to adjust interaction parameters (e.g., sliders for educational content, social interactions, emotional support, entertainment). Settings are adjusted dynamically and saved in the app.

The app sends the updated parameters to the cloud backend using HTTPS. The cloud backend processes the updates and forwards them to the doll over the established network connection. The doll's processor receives and applies the new parameters, which are then relayed to the LLM for future interactions.

Step 508: Activate setup mode. The child presses the button embedded in the doll's hand. The main processor is activated.

Step 509: Predefined Questions: The doll asks a series of predefined questions to gather essential details about the child. The types of questions include: 1) Identification: Asking the child's name and other personal identifiers; 2 Demographics: Determining the child's age and possibly their grade in school; 3) Interests and Preferences: Understanding what the child enjoys doing, their favorite subjects, hobbies, and interests; 4) Emotional State and Wellbeing: Assessing the child's current mood, emotional state, and general feelings; 5) Socio-Emotional Development: Understanding the child's social skills, friends, and family dynamics; 6) Learning Style: Gathering information on how the child prefers to learn (visual, auditory, kinesthetic); 7) Personality Traits: Asking about the child's favorite activities, books, or games to gauge their personality and interests; and 8) Health and Physical Activity: Determining the child's physical activity levels and any relevant health information.

During the questions phase, the microphone captures the child's speech and the high-definition video camera captures visual data such as facial expressions and gestures. By asking these questions, the doll can create a personalized interaction experience, adapting its responses and activities to align with the child's unique personality and preferences. This information is relayed to the LLM, which uses it to enhance future interactions, making them more relevant and engaging. The ongoing interaction helps the LLM build a comprehensive profile, enhancing the doll's ability to engage meaningfully with the child.

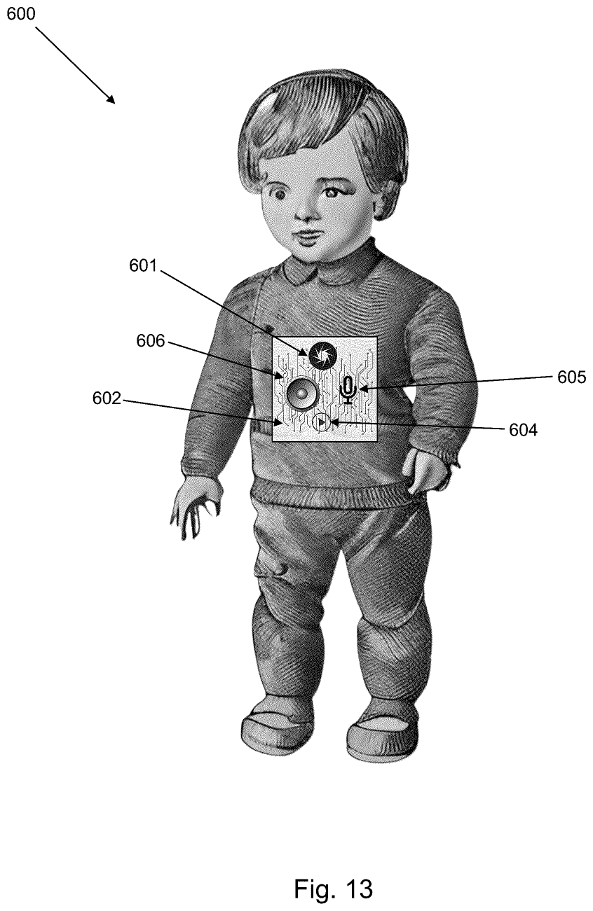

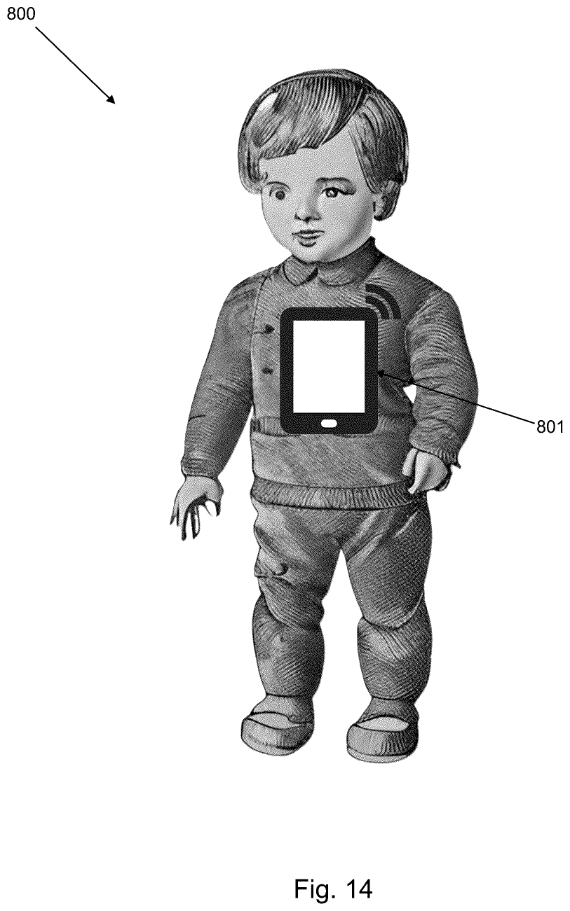

FIG. 13 is a representation of alternate embodiment of interactive doll 600 showing all of its component parts. Interactive doll 600 may be made in any form, as a doll, plush toy, animal, action figure, or any other figure. Interactive doll 600 may also take the form of an inanimate object. The representation of interactive doll 600 as a doll in this figure should not limit the shape of the device to any particular type, representation, size or material of manufacture.

In this embodiment, interactive doll 600 is created by adding a complete computing module 602 to an existing doll. Computing module 602 complete, single device that can be added to an existing doll to create an interactive doll 600. Computing module comprises video camera 601, microphone 605, button 604, speaker 606, and a battery. Computing module includes the hardware and software in control system 300 (described in relation to FIG. 3) and may connect to network 313, LLM 200, and parental control app 700.

Video camera 601 is located in a convenient location of computing module 602. Video camera 601 is utilized to capture video footage of the user of the interactive doll 600 as described in this description. In addition to video footage, still images may also be captured. In the preferred embodiment, video camera 601 is a high-definition camera with a resolution of 1920 horizontal pixels and 1080 vertical pixels or higher and is connected to the main microprocessor for data processing. Video captured by video camera 601 may be sent to the LLM for real time analysis.

Microphone 605 is located in computing module 602. In the preferred embodiment, microphone 605 is a high-quality MEMS microphone and is connected to the main microprocessor for signal processing. Any microphone well known in the art may also be utilized.

Button 604 is located for easy access on computing module 602. Button 604 is momentary push-button switch, made of durable plastic with a soft-touch surface for easy pressing in a small, discreet size, approximately 8 mm in diameter, located to so that the user may press button 604 through the cover or stuffing of the doll. Further, button 604 Includes a debouncing circuit or software to ensure reliable operation, eliminating false signals from button presses.

Interactive Doll 600 is operated by integrated software that includes all the features of the first embodiment of interactive doll 100. The software application runs on the computing module 602 and accesses LLMs through the integrated network device.

FIG. 14 is a representation of alternate embodiment of interactive doll 800 showing all of its component parts. Interactive doll 800 may be made in any form, as a doll, plush toy, animal, action figure, or any other figure. Interactive doll 800 may also take the form of an inanimate object. The representation of interactive doll 800 as a doll in this figure should not limit the shape of the device to any particular type, representation, size or material of manufacture.

In this embodiment, a complete mobile device 801, either phone or tablet, is embedded in the chest of the doll. This mobile device 802 includes a processor, memory, a touchscreen, network connectivity (WiFi, Cellular, Bluetooth™), a video/still camera, speakers, accelerometer, haptic feedback generator and a battery. The mobile device 607 may be one that is well known in the art such as devices sold by Apple™ such as the iPhone™ and iPad™, both running iOST or mobile phones/tablets running Google's Android™ operating system. Any network connected mobile device well known in the art may be utilized.

Transparent cutouts or windows are provided, aligned with the phone's screen, camera, and speaker enabling visual and auditory interaction and camera functionality. In another embodiment, the mobile device 801 is snapped into the body of the doll 800, with the screen, camera, microphone and speakers not blocked by any element of the doll and no cutouts are required. Structural components to cushion and protect the smartphone are provided to ensuring child safety and device integrity. Ventilation or heat-dissipating materials are included to manage the heat generated by the smartphone. Lastly, cutouts for essential ports and buttons of the smartphone are provided, ensuring full functionality while housed within the doll.

Interactive Doll 800 is operated by a standalone app integrating all the features of the first embodiment of interactive doll 100. The software application runs on the mobile device 801 and accesses LLMs through the integrated network device. In this embodiment, focused on low cost and simplicity, the mobile device 801 does not connect to various sensors built into the doll body. In an alternate embodiment, the mobile device 801 simply connects to an LLM app on the mobile device 801, such as ChatGPT, and the user/child accesses the features of the LLM directly through that native LLM application.

Although the present invention has been described in relation to the above disclosed preferred embodiment, many modifications in design, implementation, systems and execution are possible while still maintaining the novel features and advantages of the invention. The preferred embodiment is not meant to limit the scope of the patent in any way, and it should be given the broadest possible interpretation consistent with the language of the disclosure on the whole.

1. An interactive doll using a large language model for communicating with a user comprising:
a doll body;
a control system comprising:
a microprocessor;
a system memory;
a network interface for connecting to a network;
an audio controller;
a sensor manager for detecting signals from at least one sensor installed on the doll body;
a speaker;
a battery;
a microphone; and
a system software that processes inputs from the user comprising audio sounds input through the microphone and an input through the at least one sensor, the system software processing the audio and sensor inputs into a command set to be transmitted to a large language model via the network and an application programing interface connected to the large language model, wherein the large language model responds to the command set with a responsive communication comprising audio signals, and the responsive communication is output on the speaker of the interactive doll.

2. The interactive doll of claim 1 further comprising a video camera for capturing video signals of the user, where the command set further comprises video signals.

3. The interactive doll of claim 1 further comprising a touchscreen for displaying video signals and for accepting a touch input on the touchscreen and where the touchscreen input is included in the command set;
where the responsive communication from the large language model comprises audio signals, video signals and text signals.

4. The interactive doll of claim 2 further comprising a touchscreen for displaying video signals and for accepting a touch input on the touchscreen and the touchscreen input are included in the command set;
where the responsive communication from the large language model comprises audio signals, video signals and text signals.

5. The interactive doll of claim 1 further comprising at least one temperature sensor measuring a temperature and where the command set further comprises the temperature.

6. The interactive doll of claim 1 further comprising at least one pressure sensor measuring a pressure and where the command set further comprises the pressure.

7. The interactive doll of claim 1 further comprising at least one heart rate sensor measuring the user's heart rate and where the command set further comprises the heart rate.

8. The interactive doll of claim 1 further comprising at least one accelerometer measuring a movement vector of the interactive doll in three dimensions and where the command set further comprises the movement vector.

9. The interactive doll of claim 1 further comprising a haptic feedback generator with a haptic feedback input signal and where the responsive communication includes haptic feedback input signals.

10. The interactive doll of claim 1 where the large language model is selected from the group comprising ChatGPT, Gemini formerly known as Bard, Claude, Llama, xAI Grok, Sora, DALL-E, and SUNO.

11. The interactive doll of claim 1 where the network is the internet and the connection is wireless.

12. The interactive doll of claim 1 further comprising lighting connected to the microprocessor where the output of the lighting is controlled based on the responsive communication.

13. The interactive doll of claim 1 further comprising a parental control application connected to the interactive doll through the network and comprising setup and control functions for the interactive doll.

14. The interactive doll of claim 3 where audio content and video content stored in the system memory are displayed on the touchscreen.

15. An computing module using a large language model for communicating with a user, the computing module for use with an existing doll, comprising:
the existing doll, comprising a doll body;
the computing module comprising a microprocessor, a system memory, a network interface for connecting to a network, a microphone, a speaker, a video camera for capturing video signals of the user, and a battery;
a system software that processes inputs from the user comprising audio sounds input through the microphone, video signals through the video camera, the system software processing audio inputs and video inputs into a command set to be transmitted to a large language model via the network and an application programing interface connected to the large language model, wherein the large language model responds to the command set with a responsive communication comprising audio signals and the responsive communication is output on the speaker of the computing module.

16. The interactive doll of claim 14 where the large language model is selected from the group comprising ChatGPT, Gemini formerly known as Bard, Claude, xAI, Grok, Llama, Sora, DALL-E, and SUNO.

17. The interactive doll of claim 14 where the network is the internet and the connection is wireless.

18. An interactive doll using a large language model for communicating with a user comprising:
a doll body;
a mobile device connected to a network, the mobile device further coupled with the doll body;
the mobile device processing inputs from the user comprising audio sounds input through the microphone, video signals through the video camera and touch input through the touchscreen, the mobile device processing audio, video, and touchscreen inputs into a command set to be transmitted to a large language model via the network and an application programing interface connected to the large language model, wherein the large language model responds to the command set with a responsive communication comprising audio signals, video signals, and text signals, and the responsive communication is output on the speaker and the touchscreen of the mobile device.

19. The interactive doll of claim 17 where the mobile device runs an operating system selected from the group comprising Apple IOS operating system and Google Android operating system.

20. The interactive doll of claim 17 where the large language model is selected from the group comprising ChatGPT, Gemini formerly known as Bard, Claude, Llama, xAI, Grok, Sora, DALL-E, and SUNO.

21. The interactive doll of claim 17 where the network is the internet and the connection is wireless.
